(19) United States
(12) Patent Application Publication
(10) Pub. No.: US 2026/0161752 A1
(43) Pub. Date: Jun. 11, 2026

(54) METHOD AND DEVICE FOR PREVENTING UNAUTHORIZED ACCESS TO AN ELECTRONIC DEVICE

(71) Applicant: Lenovo (Beijing) Limited, Beijing (CN)

(72) Inventors: RANJEET GUPTA, Aurora, IL (US); Binsheng Que, Xiamen City (CN)

(21) Appl. No.: 18/976,709

(22) Filed: Dec. 11, 2024

Related U.S. Application Data
(63) Continuation of application No. PCT/CN2024/138116, filed on Dec. 10, 2024.

(51) Int. Cl. G06F 21/31

(52) U.S. Cl. CPC G06F 21/31

(57) ABSTRACT

An electronic device, a method and a computer program product for limiting access to information and accounts on the electronic device following detection of a situation placing the electronic device at risk for unauthorized access. The method includes detecting, via at least one processor of an electronic device, a trigger indicating movement of the electronic device to a position that is indicative of a security issue. In response to detecting the trigger, the method includes monitoring communication input received via a microphone. The method includes determining a context of the communication input and determining if the context indicates that the electronic device is at risk from an unauthorized access. In response to determining that the context indicates that the electronic device is at risk from an unauthorized access, the method includes activating a safe operating mode of the electronic device.

### PRIORITY APPLICATION

This application claims priority to International Application No. PCT/CN2024/138116 filed Dec. 10, 2024, the contents of which are fully incorporated herein by reference.

### BACKGROUND

### 1. Technical Field

The present disclosure generally relates to electronic devices and in particular to preventing unauthorized access to an electronic device.

### 2. Description of the Related Art

Electronic devices, such as mobile phones, tablets, and laptops, are widely used for video, voice, and text communication and for data transmission. Electronic devices are also used with various applications to access financial accounts and to purchase goods and services. Electronic devices can also store confidential and/or private data and information such as passwords, photos, and video(s).

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices within a connected device ecosystem, according to one or more embodiments;

FIG. 2 is a block diagram of example contents of the memory subsystem of the example electronic device of FIG. 1A-1B (FIG. 1) configured to complete the various processes described herein, according to one or more embodiments;

FIG. 3 illustrates an example scenario in which an authorized user of an electronic device 100 is subject to a robbery or theft of the electronic device, according to one or more embodiments;

FIG. 4A is an example illustration of a display of an electronic device presenting a normal operating mode graphical user interface (GUI), according to one or more embodiments;

FIG. 4B is an example illustration of a display of an electronic device presenting a safe operating mode GUI, after determining that the electronic device is at risk of unauthorized access, according to one or more embodiments;

FIG. 5 is an example illustration of a display of an electronic device presenting an authentication GUI that includes an example passcode entry window, according to one or more embodiments;

FIG. 6 depicts a flowchart of a method by which an electronic device enters a safe operating mode to limit access to information and accounts on the electronic device following detection of a situation placing the electronic device at risk of an unauthorized access, according to one or more embodiments; and

FIG. 7 depicts a flowchart of a method by which an electronic device identifies the context of received communication input in determining whether the electronic device is at risk of unauthorized access, according to one or more embodiments.

### DETAILED DESCRIPTION

According to one or more aspects of the disclosure, the illustrative embodiments provide an electronic device, a method, and a computer program product for limiting access to information and accounts on the electronic device following detection of a situation placing the electronic device at risk for unauthorized access.

Situations can arise where an electronic device is stolen/taken from a user by a thief or other person who may have the user's login password or who may be able to decipher the password and gain access to the user's electronic device. In such scenarios, the nefarious person can then have unlimited access to the user's financial records/accounts, credit card accounts, retail store or restaurant account, etc. Significant damage can be done before the user is able to take steps to close or suspend the electronic accounts that are directly accessible from the user's electronic device. Private data and images/video stored on the user's electronic device are also placed at risk. An unauthorized user may be able to (i) access the financial accounts of the user and withdraw money, (ii) purchase goods or services using credit or financial accounts stored on the device, and/or (iii) change account passwords such that only the unauthorized user is able to access the particular accounts. In addition, an unauthorized user may be able to delete or misuse information and data stored on the electronic device. The embodiments disclosed herein addresses and overcome the aforementioned situations, which involve/result in a breach of security and unauthorized access to the user's data and accounts, by autonomously increasing by limiting access to information and accounts on the electronic device following detection of a situation placing the electronic device at risk for unauthorized access. The embodiments disclosed herein enable an electronic device to detect movement of the electronic device to a hand-held position that can be indicative of a security issue, such as a threat situation, and to contemporaneously detect a threat phrase spoken by the user or the nefarious person. The embodiments disclosed herein increase security of an electronic device by blocking access to a user's personal/private files and device-accessible accounts by unauthorized users when a threat situation is detected.

In a first embodiment, an electronic device includes at least one input device comprising a microphone, at least one sensor that detects changes in a position and movement of the electronic device, and a memory having stored thereon an electronic device theft protection module for limiting access to information and accounts on the electronic device following determination of a situation placing the electronic device at risk for unauthorized access. The electronic device includes at least one processor that is communicatively coupled to each of the at least one sensor, the at least one input device, and the memory, and which executes program code of the electronic device theft protection module. The at least one processor is configured to cause the electronic device to detect a trigger indicating a first movement of the electronic device to a first position that is indicative of a security situation. In response to detecting the trigger, the at least one processor monitors first communication input received via the microphone. The first communication input corresponds to received speech from a current environment of the electronic device. The at least one processor determines a first context of the first communication input, in part based on the electronic device being contemporaneously moved into the first position, and the at least one processor determines if the first context indicates that the electronic device is at risk of unauthorized access. In response to determining that the first context indicates that the electronic device is at risk from unauthorized access, the at least one processor activates a safe operating mode of the electronic device. The safe operating mode at least partially prevents unauthorized access to at least one application or account accessible via the electronic device.

According to another embodiment, the method includes determining, via at least one processor of an electronic device, a trigger indicating a first movement of the electronic device to a first position that is indicative of a security issue. In response to detecting the trigger, the method includes monitoring first communication input received via a microphone. The first communication input corresponds to received speech from a current environment of the electronic device. The method includes determining a first context of the first communication input, in part based on the electronic device being contemporaneously moved into the first position, and the at least one processor determining if the first context indicates that the electronic device is at risk of unauthorized access. In response to determining that the first context indicates that the electronic device is at risk from an unauthorized access, the method includes activating a safe operating mode of the electronic device. The safe operating mode at least partially prevents unauthorized access to at least one application or account accessible via the electronic device.

According to an additional embodiment, a computer program product includes a computer readable storage device having stored thereon program code that, when executed by at least one processor of an electronic device having at least one input device comprising a microphone and at least one sensor that detects changes in a position and movement of the electronic device, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

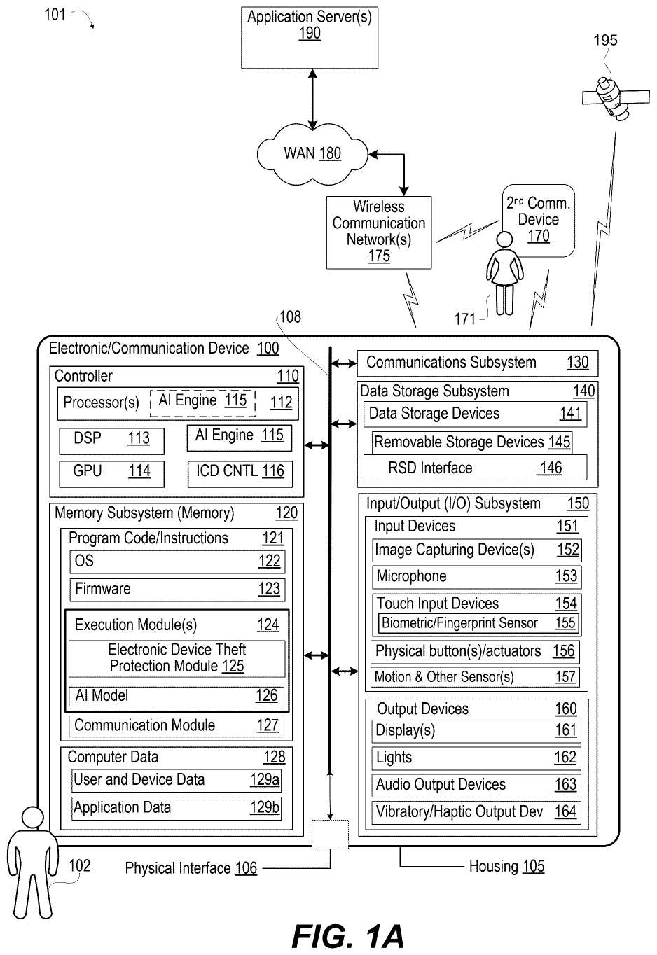

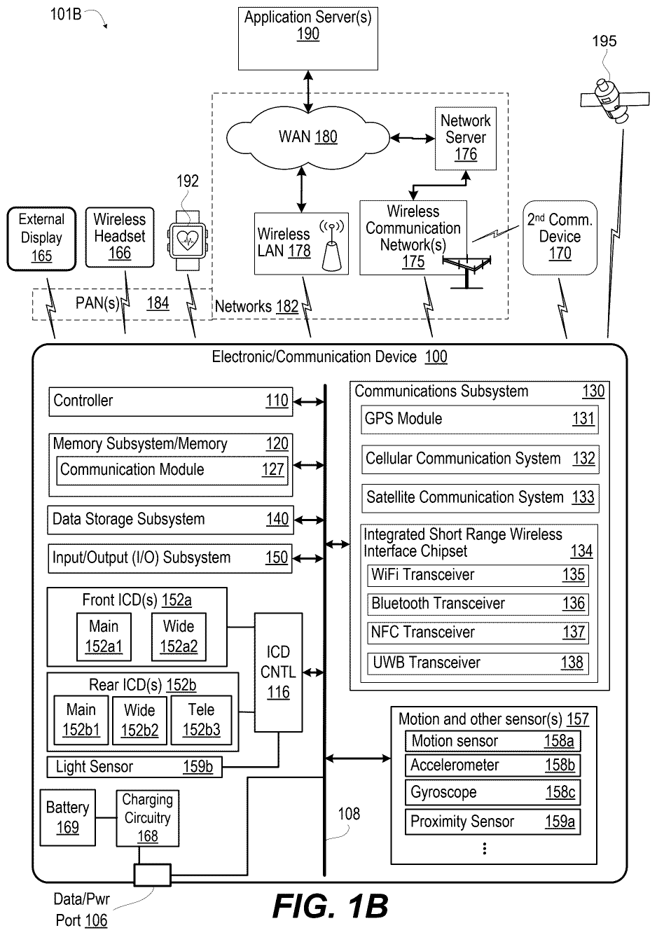

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of communication device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, electronic device theft protection module 125, which provides the features and operating functionality of the disclosed embodiments when the corresponding program instructions of electronic device protection module 125 are processed by/within processor 112/controller 110. Specifically, electronic device theft protection module 125 provides program instructions for limiting access to information and accounts on the electronic device following detection of a situation placing the electronic device at risk of unauthorized access.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within electronic device theft protection module 125 and is trained to support the AI features of electronic device theft protection module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, electronic device theft protection module 125 can include program instructions that cause or configure processor 112 to cause electronic device 100 to limit access to information and accounts on the electronic device following detection of a situation placing the electronic device at risk for unauthorized access. Other features provided by electronic device theft protection module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of electronic device theft protection module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 151. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone that is used by a second user 171, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of electronic device theft protection module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can also be used as a power supply port that is coupled to charging circuitry 168, which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 include front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152 a can include a main camera 152a1 and a wide angle camera 152a2. Rear cameras can include a main camera 152b1, a wide angle camera 152b2, and a telephoto camera 152b3. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

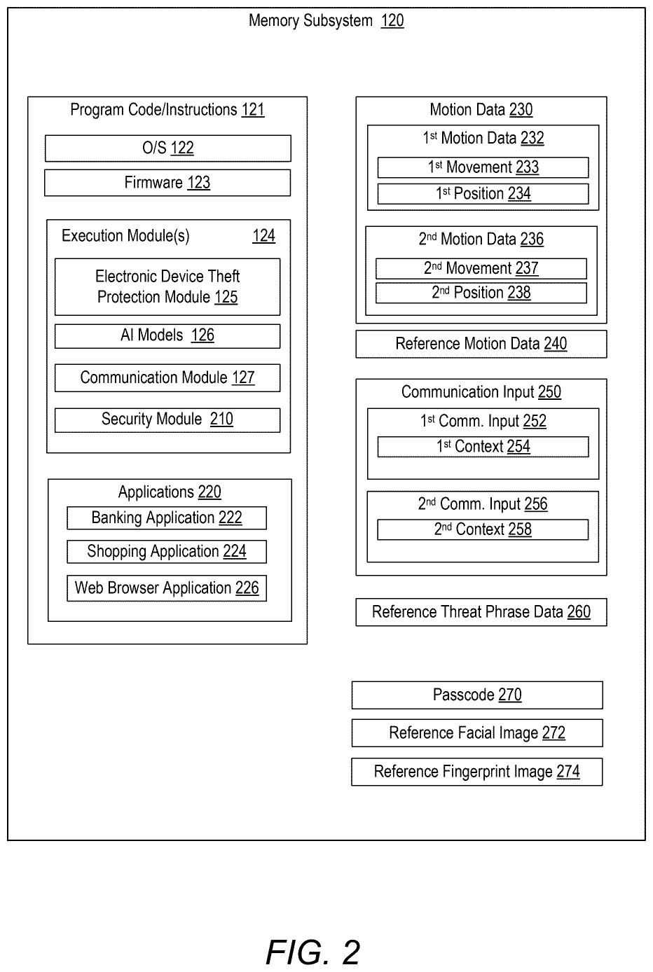

Referring to FIG. 2, there is shown one embodiment of example contents of memory subsystem 120 of electronic device 100 configured to complete the various processes described herein. Memory subsystem 120 includes program code/instructions 121 including data, software, and/or firmware modules, such as operating system (O/S) 122, firmware 123, execution module(s) 124 and applications 220. Execution module(s) 124 include electronic device theft protection module 125, security module 210, AI models 126, and communication module 127.

Applications 220 include banking application 222, shopping application 224, and web browser application 226. Banking application 222 includes program code that is executed by processor 112 to enable electronic device 100 to access banking services provided by a bank or other financial institution, such as a credit card company, online payment service, etc. Shopping application 224 includes program code that is executed by processor 112 to enable electronic device 100 to access websites to view, browse and buy products or services from a retailer or service provider. Web browser application 226 includes program code that is executed by processor 112 to enable electronic device 100 to access various websites of the Internet, including password-accessible personal pages on the websites. While only three applications are shown, applications 220 can include more or fewer than three applications.

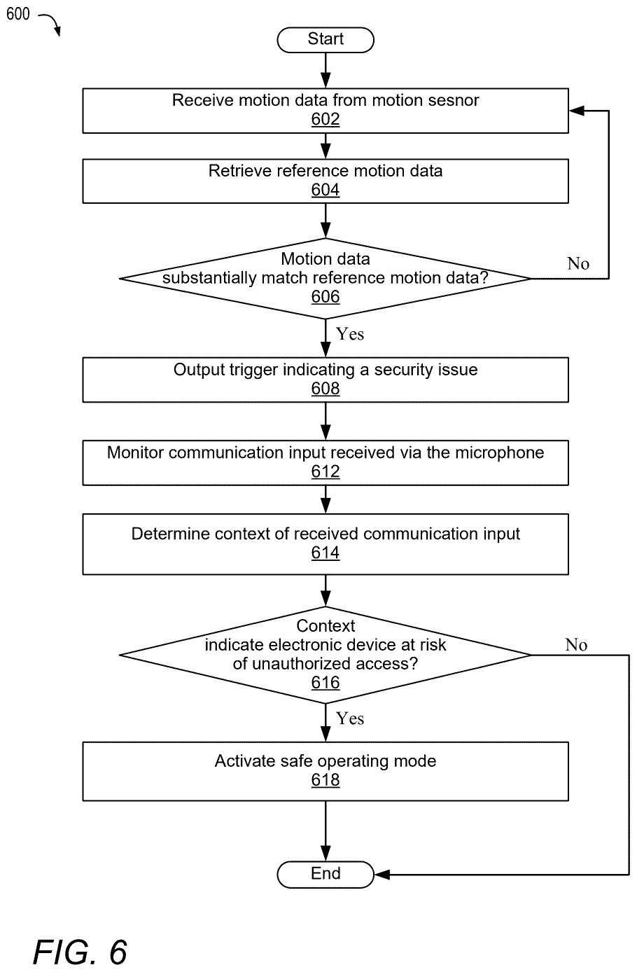

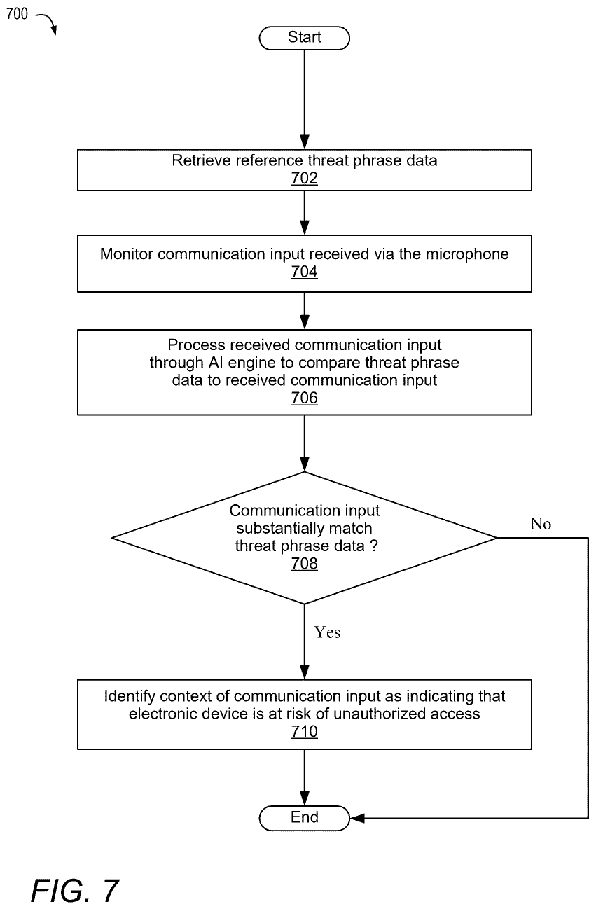

Electronic device theft protection module 125 includes program code that is executed by processor 112 to enable electronic device 100 to perform the various features of the present disclosure. In one or more embodiments, electronic device theft protection module 125 enables electronic device 100 to limit access to information and accounts on the electronic device following detection of a situation placing the electronic device at risk for unauthorized access. In one or more embodiments, execution of electronic device theft protection module 125 by processor 112 configures electronic device 100 to perform the processes presented in the flowcharts of FIGS. 6 and 7, as will be described below.

Security module 210 enables electronic device 100 to perform a facial recognition process, other biometric authentication process, and/or a passcode verification to authenticate the identity of a user of the electronic device. AI models 126 accelerate artificial intelligence, natural language processing (NLP), context evaluation (CE), and machine learning applications. Communication module 127 enables electronic device 100 to communicate and exchange data with other devices via networks 182.

Memory subsystem 120 includes motion data 230 and reference motion data 240. Motion data can be sensed and/or detected by one or more motion and other sensors 157 of electronic device 100. Motion data 230 includes first motion data 232 and second motion data 236. Motion data 230 indicates the spatial orientation, position and movement of electronic device 100. First motion data 232 includes first movement 233 and first position 234. Second motion data 236 includes second movement 237 and second position 238. In one embodiment, motion data 230 can contain data and information that tracks the position, orientation and movement of electronic device 100. Reference motion data 240 is pre-determined movement to a position that is pre-identified as indicative of a potential security issue affecting user possession of electronic device 100.

Memory subsystem 120 includes communication input 250. Communication input 250 is audio that is received via microphone 153. In one embodiment, communication input 250 can correspond to speech received form one or more individuals in an environment of electronic device 100. Communication input 250 includes first communication input 252 and second communication input 256. First communication input 252 includes first context 254 and second communication input 256 includes second context 258. First context 254 is a security-related meaning attributed to first communication input 252 and second context 258 is a security-related meaning attributed to second communication input 256. A security-related meaning of the context corresponds to potential harm that can be caused by a hostile person or persons, such as a thief.

In one embodiment, electronic device 100 can determine the context or meaning of communication inputs 252 and 256 using AI processing. In one or more embodiments, electronic device 100 can process communication inputs 252 and 256 through AI engine 115 to determine the context.

Memory subsystem 120 includes reference threat phrase data 260. Reference threat phrase data 260 are pre-determined phrases that indicate that electronic device 100 may be in a threat situation such as a robbery. In one example embodiment, threat phrase data may include phrases such as, “stop, give me phone”, or “give me the password” spoken by an unknown speaker, or “please don't hurt me” or “please don't take my phone” spoken by the user.

Memory subsystem 120 includes passcode 270 and reference facial image 272 and fingerprint image 274. Passcode 270 is a code that is input by a user to electronic device 100 to transition the electronic device from a safe mode or safe operating mode to a normal mode or normal operating mode. Reference facial image 272 is a facial image of a registered or authenticated user of electronic device 100 that is stored during a facial enrollment process. Reference fingerprint image 274 is an image of a registered or authenticated fingerprint from a user of electronic device 100 that is stored during a fingerprint enrollment process. In one embodiment, a current captured facial image can be compared to reference facial image 272 in order to transition the electronic device from a safe mode or safe operating mode to a normal mode or normal operating mode. Similarly, in one embodiment, a current fingerprint image can be compared to reference fingerprint image 274 in order to transition the electronic device from a safe mode or safe operating mode to a normal mode or normal operating mode. In one or more embodiments, a different, potentially more complicated, restore password can be compared to a stored master restore password that is different from the normal passcode login in order to transition the electronic device from a safe mode or safe operating mode to a normal mode or normal operating mode.

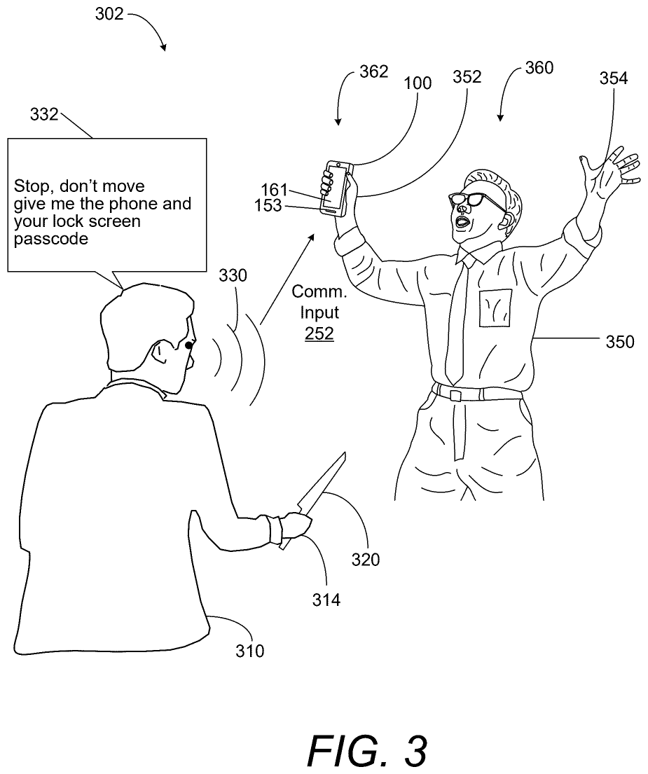

FIG. 3 illustrates an example scenario 302 in which a user of an electronic device 100 is subject to a robbery or theft of the electronic device, according to one or more embodiments. A thief 310 is shown stealing electronic device 100 from an authorized user 350 of the electronic device. Thief 310 is brandishing a knife 320 in their hand 314 to threaten user 350. Electronic device 100 is held by hand 352 of user 350. In reaction to the actions of thief 310, user 350 has moved their hand 352 with electronic device 100 to the ‘hands up’ surrender posture 360. Both of user's hands, hand 352 and hand 354, are shown outstretched in the hands up surrender posture 360. User 350 has thus moved electronic device 100 from a first position and location to the hands up position 362.

During the robbery, thief 310 is shown speaking words or speech 330 with speech content 332. Speech content 332 is shown as “Stop, don't move, give me the phone and your lock screen passcode”. Conventionally, once the thief 310 gains possession of electronic device 100 with the lock screen passcode, the thief 310 would be able to perform malicious operations on/with the electronic device 100, such as accessing financial accounts to withdraw funds, changing passwords on user accounts, purchasing goods and services for themselves, and deleting data from electronic device 100.

Speech 330 from thief 310 is detected by microphone 153 of electronic device 100 as first communication input 252 (FIG. 2). In one embodiment, electronic device 100 can transcribe first communication input 252 into text (i.e., perform speech to text or speech recognition) using natural language processing (NLP) and artificial intelligence (AI) processing. Electronic device 100 can further determine the context or meaning of first communication input 252 using AI processing. Electronic device 100 can determine the meaning of first communication input 252 using AI processing. In one embodiment, electronic device 100 can process first communication input 252 through AI engine 115 to determine the first security-related context 254 of speech 330. Electronic device 100 can determine if the electronic device is in a threat situation, where the electronic device is at risk of unauthorized access, at least partially based on the detected first communication input 252.

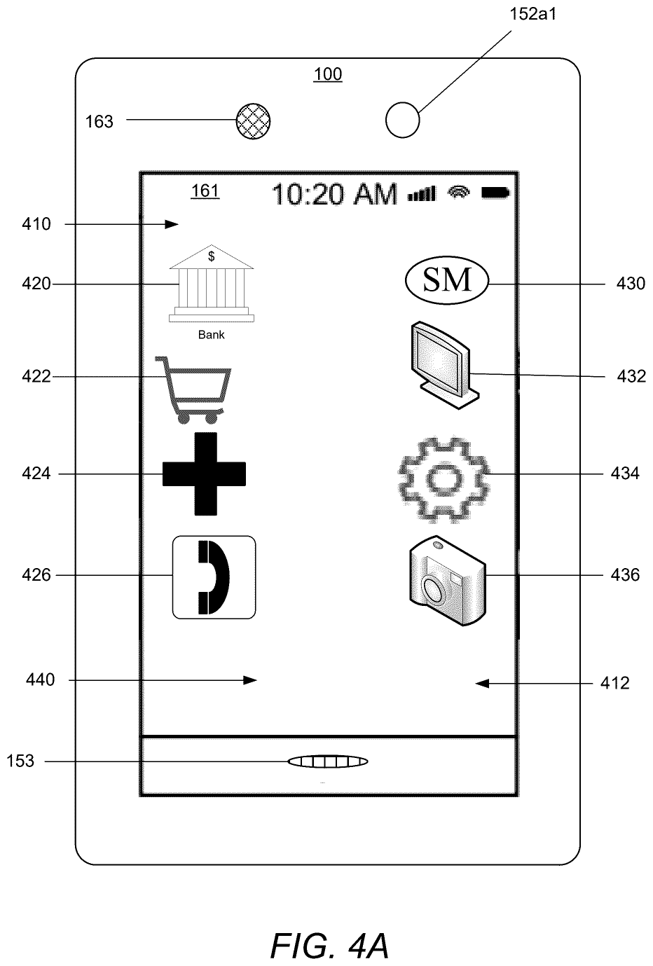

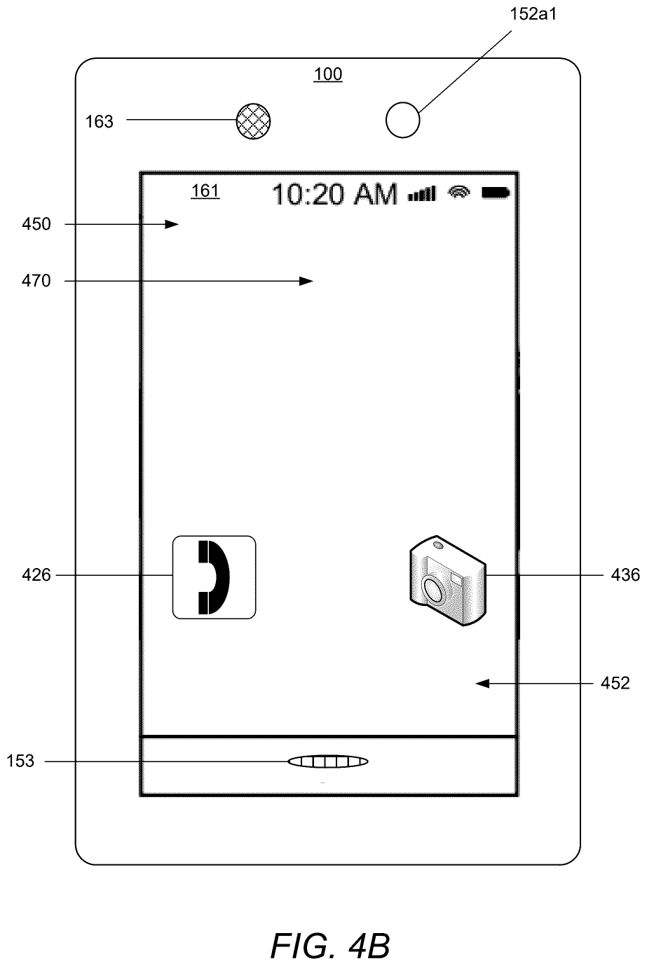

With reference to FIG. 4A, electronic device 100 is shown with an example normal operating mode graphical user interface (GUI) 410 presented on display 161 that allows a user to access various functions and applications 220 of electronic device 100. In one example embedment, normal operating mode 440 can allow a user of electronic device to make phone calls, view e-mail messages, send and receive text messages, perform banking services, and purchase goods and services from a merchant.

Normal operating mode GUI 410 includes a normal mode icon selection interface page 412 that includes several icons that, when selected by a user of electronic device 100, initiate one or more functions/applications of the electronic device. Normal mode icon selection interface page 412 includes banking icon 420, shopping icon 422, health care icon 424, phone icon 426, social media icon 430, entertainment icon 432, settings icon 434, and camera icon 436.

In one embodiment, banking icon 420, shopping icon 422, health care icon 424, social media icon 430, and entertainment icon 432 are icons that initiate third party applications that at least partially utilize resources that are external to electronic device 100. In one example embodiment, selection of banking icon 420 can initiate banking application 222 that utilizes resources of an external banking computer system to provide banking/financial functions and services. In one or more embodiments, banking icon 420, shopping icon 422, health care icon 424, social media icon 430, and entertainment icon 432 provide access to a corresponding application/service/function that can be separately accessible via respective login credentials, which are auto-filled in at a login portal when the access is detected from the user's electronic device 100. Phone icon 426, settings icon 434, and camera icon 436 are icons that initiate functions/applications that are native to electronic device 100.

Turning to FIG. 4B, electronic device 100 is shown with an example safe operating mode graphical user interface (GUI) 450 presented on display 161. When electronic device 100 is in a safe operating mode 470, access to various functions and applications 220 of the electronic device is prevented. The safe operating mode 470 is an operating system mode of the electronic device that disables some or all third party applications. Third party applications are applications that were not original equipment manufacturer (OEM)-installed with electronic device 100 during manufacturing and/or configuration of the electronic device (i.e., the third party applications were installed later). The safe operating mode 470 prevents access to third party applications by removing from display 161 icons that represent the applications in order to prevent access to these applications by an unauthorized user, such as a thief. Safe operating mode 470 can prevent access to financial and shopping applications, which a thief could use to steal money and goods and services. In one embodiment, while the electronic device is in the safe operating mode, only applications, functions and services that were pre-installed during manufacturing and/or configuration of the electronic device will be available. Additionally, in one or more embodiments, certain pre-installed applications are also not made available during safe operating mode 470. In one example embodiment, the safe operating mode 470, removes a pre-installed settings icon 434, preventing access to a settings application that can enable deletion of electronic device data such as computer data 128. Also, in one or more alternate embodiments, certain third-party applications can be presented during device operation in safe operating mode.

Safe operating mode GUI 450 includes a safe mode icon selection interface page 452 that includes several icons that, when selected by a user of electronic device 100, initiate one or more functions/applications of the electronic device. Safe mode selection interface page 452 includes phone icon 426 and camera icon 436. In the safe operating mode, banking icon 420, shopping icon 422, health care icon 424, social media icon 430, entertainment icon 432, and settings icon 434 (FIG. 4A) have been de-activated/removed to prevent access to these applications and/or secure information of the electronic device by an unauthorized user. In the safe operating mode, a user (including a thief) of electronic device 100 can select phone icon 426 and camera icon 436. The safe operating mode prevents an unauthorized user (including a thief) from accessing various functions and applications. In one example embodiment, the safe operating mode 470, removes banking icon 420, preventing access to banking application 222 and blocking possible theft/misappropriation of funds and/or the changing of account passwords by a thief. In another example embodiment, the safe operating mode 470, removes shopping icon 420, preventing access to shopping application 224 and blocking possible unauthorized purchase of goods and services and/or changing of account passwords by a thief. In an additional example embodiment, the safe operating mode 470 can allow access to applications that are deemed to not have a security risk such, as a phone application or a camera application.

According to one aspect of the disclosure, electronic device 100 can determine, via motion data received from motion sensors 157, a trigger indicating movement of the electronic device to the first position 362 that is indicative of a security situation placing the electronic device at risk for unauthorized access. In response to detecting the trigger, electronic device 100 monitors first communication input 252 received via microphone 153. The communication input 252 corresponds to received speech 330 from a current environment scenario 302 of electronic device 100. Electronic device 100 determines a first context 254 of the first communication input 252 and determines if the first context 254 indicates that the electronic device is at risk from unauthorized access. In response to determining that the first context 254 indicates that the electronic device is at risk from unauthorized access, electronic device 100 activates safe operating mode 470 of the electronic device. The safe operating mode 470 at least partially prevents unauthorized access to at least one application 220 or account accessible via the electronic device.

According to one aspect of the disclosure, electronic device 100 can receive, from the at least one motion sensor 157, first motion data 232 and retrieve reference motion data 240. The reference motion data provides the movement of electronic device 100 from a normal position to the position 362 that is indicative of a particular security situation. Electronic device 100 determines if the first motion data 232 substantially matches the reference motion data 240. In response to determining that the first motion data 232 substantially matches the reference motion data 240, electronic device 100 outputs the trigger indicating detection of the security issue.

According to an additional aspect of the disclosure, in response to activation of the safe operating mode, electronic device 100 de-activates at least one application 220 of the electronic device to prevent access to secure information accessible via the at least one application.

According to one more aspect of the disclosure, in response to activation of the safe operating mode 470, electronic device 100 prevents deletion of user data 129a from the electronic device. In one or more embodiments, electronic device 100 can deactivate the ‘delete’ icon or functions from being accessible during the safe mode. In one or more embodiments, electronic device 100 can deactivate settings icon 434 or functions from being accessible during the safe operating mode.

According to yet another aspect of the disclosure, in response to activation of the safe operating mode 470, electronic device 100 blocks presentation of at least one icon (e.g., icon 420) on the display device 161. The at least one icon is associated with at least one application 220. In one or more embodiments, the at least one icon is presented on the display when the safe mode is not activated.

According to one more additional aspect of the disclosure, electronic device 100 retrieves threat phrase data 260. Electronic device 100 processes the first communication input 252 and the threat phrase data 260 through an artificial intelligence engine 115 to compare the first communication input 252 to the threat phrase data 260. In response to the first communication input 252 substantially matching at least a portion of the threat phrase data 260, electronic device 100 identifies the first context 254 as indicating that the electronic device is at risk from unauthorized access.

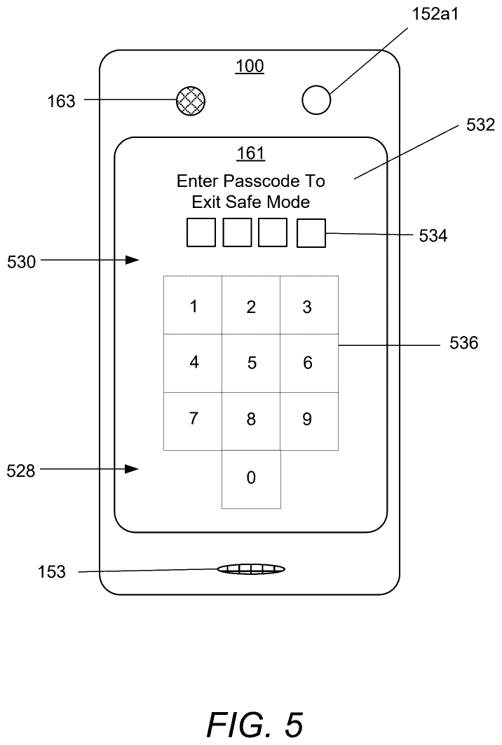

FIG. 5 illustrates an example authentication GUI 530 presented on display 161 of electronic device 100. In one embodiment, entry into safe mode 470 can automatically trigger a pre-determined waiting time period. After the pre-determined waiting time period has expired, electronic device 100 can present authentication GUI 530 on display 161. The waiting time period is a period of time after the electronic device has been stolen or otherwise compromised and the safe operating mode 470 has been activated. The waiting time period allows a user to contact authorities such as the police, to contact their communication service provider, and to contact various account providers to prevent various malicious acts. During the waiting time period, a user can suspend communication services to the electronic device by their communication service provider and/or restrict/block access to various accounts such as financial accounts, shopping accounts and social media accounts. Authentication GUI 530 includes a passcode interface page 528 that prompts for entry of a passcode 270. Passcode interface page 528 includes a prompt 532 to enter a passcode to exit the safe operating mode 470 and return to the normal operating mode 440, a passcode entry window 534, and a dial-pad 536 for a user to use to input the passcode. A user can input the passcode 270 using dial-pad 536 in order to exit the safe operating mode and return to the normal operating mode. In one or more embodiments, the passcode to exit the safe operating mode 470 can be different than the normal unlock screen passcode. The passcode to exit the safe operating mode 470 can be a more complicated restore password that can be compared to a stored master restore password that is different from the normal login passcode in order to transition the electronic device from a safe mode or safe operating mode to a normal mode or normal operating mode. In another embodiment, a current fingerprint image can be captured via fingerprint sensor 155 and compared to reference fingerprint image 274 in order to transition the electronic device from a safe mode or safe operating mode to a normal mode or normal operating mode.

According to one aspect of the disclosure, electronic device 100 can output authentication GUI 530 on the display 161. Authentication GUI 530 includes a passcode interface page 528 prompting for entry of a passcode 270 to transition the electronic device from the safe operating mode 470 to a normal operating mode 440.

According to another aspect of the disclosure, after the pre-determined waiting time period has expired, electronic device 100 can trigger at least one camera 152 to capture a first facial image. Electronic device 100 can retrieve a reference facial image 272. Electronic device 100 can determine if the first facial image substantially matches the reference facial image 272. In response to the first facial image substantially matching the reference facial image 272, electronic device 100 can transition the electronic device from the safe operating mode 470 to a normal operating mode 440.

FIG. 6 depicts method 600 by which electronic device 100 limits access to information and accounts on the electronic device following detection of a situation placing the electronic device at risk of unauthorized access. FIG. 7 depicts method 700 by which electronic device 100 identifies a context of received communication input to the electronic device.

The description of methods 600 and 700 will be described with reference to the components and examples of FIGS. 1-5. The operations depicted in FIGS. 6 and 7 can be performed by electronic device 100 or any suitable electronic device that includes the one or more functional components of electronic device 100 that provide/enable the described features. One or more of the processes of the methods described in FIGS. 6 and 7 may be performed by processor 112 executing program code associated with electronic device theft protection module 125.

With specific reference to FIG. 6, method 600 begins at the start block. At block 602, method 600 includes receiving motion data 230 from motion sensors 157. Method 600 includes retrieving reference motion data 240 from memory subsystem 120 (block 604). The reference motion data includes a movement to a position 362 that is indicative of a security issue. Method 600 includes determining if the first motion data 232 substantially matches the reference motion data 240 (e.g., first movement 233 and first position 234 substantially match reference motion data 240) (decision block 606). In response to determining that the first motion data 232 does not substantially match the reference motion data 240, method 600 continues to receive motion data 230 from motion sensors 157 (block 602). In response to determining that the first motion data 232 substantially matches the reference motion data 240, method 600 includes outputting a trigger indicating movement of the electronic device to a position 362 that is indicative of a security issue (block 608).

Method 600 includes in response to detecting the trigger, monitoring communication input 250 received via microphone 153 (block 612). The communication input 250 corresponds to received speech 330 from a current environment scenario 302 of electronic device 100. In one or more embodiments, microphone 153 can be in an always on audio mode that captures and stores/buffers to memory the last 10 or more seconds of received audio communication input 252. The timing of the received communication input 252 can be checked from 10 seconds before the current time to include communication input that occurs before movement of the electronic device user's 350 hands. Method 600 includes determining a first context 254 of first communication input 252 (block 614). At block 616, method 600 includes determining if the first context 254 indicates that the electronic device is at risk from an unauthorized access. In response to determining that the first context 254 indicates that the electronic device is not at risk from an unauthorized access, method 600 ends at the end block.

In response to determining that the first context 254 indicates that the electronic device is at risk from an unauthorized access, method 600 includes activating safe operating mode 470 of electronic device 100 (block 618). The safe operating mode 470 at least partially prevents unauthorized access to at least one application 220 or account accessible via electronic device 100. The safe operating mode 470 also prevents unwanted deletion of user data 129a from the electronic device by unauthorized users. Method 600 terminates at the end block.

FIG. 7 depicts method 700 by which electronic device 100 identifies communication input to the electronic device as indicating that the electronic device is potentially at risk from unauthorized access. With specific reference to FIG. 7, method 700 begins at the start block. At block 702, method 700 includes retrieving threat phrase data 260 from memory subsystem 120. Method 700 includes receiving communication input 250 from microphone 153 or retrieving buffered communication input from memory subsystem 120 (block 704).

Method 700 includes processing the communication input 250 and the threat phrase data 260 through an artificial intelligence engine 115 to compare the first communication input 250 to the threat phrase data 260 (block 706). Method 700 includes determining if the communication input 250 substantially matches at least a portion of the threat phrase data 260 (decision block 708). In response to the communication input 250 not substantially matching at least a portion of the threat phrase data 260, method 700 ends at the end block. In response to the communication input 250 substantially matching at least a portion of the threat phrase data 260, method 700 includes identifying a context (e.g., first context 254) of the communication input (e.g., first communication input 252) as indicating that the electronic device is at risk from unauthorized access (block 710). Method 700 terminates at the end block.

The disclosure provides a user of an electronic device increased security by limiting access to information and accounts on the electronic device following detection of a situation placing the electronic device at risk for an unauthorized access. The disclosure enables an electronic device to detect movement of the electronic device to a position that is potentially indicative of a security issue. The disclosure enables detecting threat phrase communication input from a current environment of the electronic device that indicates that the electronic device is at risk from unauthorized access. The disclosure enables activating a safe operating mode to prevent unauthorized access to applications, user accounts, and data accessible via the electronic device. The disclosure increases security of an electronic device by blocking access to unauthorized users when a threat situation is detected.

In the above-described methods of FIGS. 6 and 7, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one input device comprising a microphone;
at least one sensor that detects changes in a position and movement of the electronic device;
a memory having stored thereon an electronic device theft protection module for limiting access to information and accounts on the electronic device following detection of a situation placing the electronic device at risk for an unauthorized access; and
at least one processor communicatively coupled to each of the at least one sensor, the at least one input device, and the memory, and which executes program code of the electronic device theft protection module, the at least one processor configured to cause the electronic device to:
detect a trigger indicating a first movement of the electronic device to a first position that is indicative of a security issue;
in response to detecting the trigger, monitor first communication input received via the microphone, the first communication input corresponding to received speech from a current environment of the electronic device;
determine a first context of the first communication input;
determine if the first context indicates that the electronic device is at risk from an unauthorized access; and
in response to determining that the first context indicates that the electronic device is at risk from an unauthorized access, activate a safe operating mode of the electronic device, the safe operating mode at least partially preventing unauthorized access to at least one application or account accessible via the electronic device.

2. The electronic device of claim 1, wherein:
the at least one sensor comprises a motion sensor; and
to detect the trigger, the at least one processor is configured to cause the electronic device to:
receive, from the at least one motion sensor, first motion data;
retrieve reference motion data, the reference motion data including the first movement to the first position that is indicative of the security issue;
determine if the first motion data substantially matches the reference motion data; and
in response to determining that the first motion data substantially matches the reference motion data, output the trigger indicating the security issue.

3. The electronic device of claim 1, wherein the at least one processor is configured to:
in response to activation of the safe operating mode, de-activate at least one application of the electronic device to prevent access to secure information of the at least one application.

4. The electronic device of claim 1, wherein the at least one processor is configured to:
in response to activation of the safe operating mode, prevent deletion of user data from the electronic device.

5. The electronic device of claim 1, further comprising:
at least one display that is communicatively coupled to the at least one processor, and wherein the at least one processor is configured to:
in response to activation of the safe operating mode, block presentation of at least one icon on the display, the at least one icon associated with at least one application, the at least one icon being presented on the display when the safe mode is not activated.

6. The electronic device of claim 1, wherein the at least one processor is configured to:
retrieve threat phrase data;
process the first communication input and the threat phrase data through an artificial intelligence engine to compare the first communication input to the threat phrase data; and
in response to the first communication input substantially matching at least a portion of the threat phrase data, identify the first context as indicating that the electronic device is at risk from an unauthorized access.

7. The electronic device of claim 1, further comprising:
at least one display that is communicatively coupled to the at least one processor, and wherein the at least one processor is configured to:
output a first graphical user interface (GUI) on the display, the first GUI including a passcode interface prompting for entry of a first passcode to transition the electronic device from the safe operating mode to a normal operating mode.

8. The electronic device of claim 1, further comprising:
at least one camera that is communicatively coupled to the at least one processor, and wherein the at least one processor is configured to:
trigger the at least one camera to capture a first facial image;
retrieve a reference facial image;
determine if the first facial image substantially matches the reference facial image; and
in response to the first facial image substantially matching the reference facial image, transition the electronic device from the safe operating mode to a normal operating mode.

9. A method comprising:
detecting, via at least one processor of an electronic device, a trigger indicating a first movement of the electronic device to a first position that is indicative of a security issue;
in response to detecting the trigger, monitoring first communication input received via a microphone, the first communication input corresponding to received speech from a current environment of the electronic device;
determining a first context of the first communication input;
determining if the first context indicates that the electronic device is at risk from an unauthorized access; and
in response to determining that the first context indicates that the electronic device is at risk from an unauthorized access, activating a safe operating mode of the electronic device, the safe operating mode at least partially preventing unauthorized access to at least one application or account accessible via the electronic device.

10. The method of claim 9, wherein the electronic device further comprises at least one motion sensor and to detect the trigger, the method further comprises:
receiving, from the at least one motion sensor, first motion data;
retrieving reference motion data, the reference motion data including the first movement to the first position that is indicative of the security issue;
determining if the first motion data substantially matches the reference motion data; and
in response to determining that the first motion data substantially matches the reference motion data, outputting the trigger indicating the security issue.

11. The method of claim 9, further comprising:
in response to activation of the safe operating mode, de-activating at least one application of the electronic device to prevent access to secure information of the at least one application.

12. The method of claim 9, further comprising:
in response to activation of the safe operating mode, preventing deletion of user data from the electronic device.

13. The method of claim 9, wherein the electronic device further comprises at least one display, the method further comprises:
in response to activation of the safe operating mode, blocking presentation of at least one icon on the display, the at least one icon associated with at least one application, the at least one icon being presented on the display when the safe mode is not activated.

14. The method of claim 9, further comprising:
retrieving threat phrase data;
processing the first communication input and the threat phrase data through an artificial intelligence engine to compare the first communication input to the threat phrase data; and
in response to the first communication input substantially matching at least a portion of the threat phrase data, identifying the first context as indicating that the electronic device is at risk from an unauthorized access.

15. The method of claim 9, wherein the electronic device further comprises at least one display, and the method further comprises outputting a first graphical user interface (GUI) on the display, the first GUI including a passcode interface prompting for entry of a first passcode to transition the electronic device from the safe operating mode to a normal operating mode.

16. The method of claim 9, wherein the electronic device further comprises at least one camera, the method further comprises:
triggering the at least one camera to capture a first facial image;
retrieving a reference facial image;
determining if the first facial image substantially matches the reference facial image; and
in response to the first facial image substantially matching the reference facial image, transitioning the electronic device from the safe operating mode to a normal operating mode.

17. A computer program product comprising:
a computer readable storage device having stored thereon program code which, when executed by at least one processor of an electronic device having at least one input device comprising a microphone and at least one sensor that detects changes in a position and movement of the electronic device, configures the electronic device to complete the functionality of:
detecting a trigger indicating a first movement of the electronic device to a first position that is indicative of a security issue;
in response to detecting the trigger, monitoring first communication input received via the microphone, the first communication input corresponding to received speech from a current environment of the electronic device;
determining a first context of the first communication input;
determining if the first context indicates that the electronic device is at risk from an unauthorized access; and
in response to determining that the first context indicates that the electronic device is at risk from an unauthorized access, activating a safe operating mode of the electronic device, the safe operating mode at least partially preventing unauthorized access to at least one application or account accessible via the electronic device.

18. The computer program product of claim 17, wherein the at least one sensor comprises at least one motion sensor and the program code further configures the electronic device to complete the functionality of:
receiving, from the at least one motion sensor, first motion data;
retrieving reference motion data, the reference motion data including the first movement to the first position that is indicative of the security issue;
determining if the first motion data substantially matches the reference motion data; and
in response to determining that the first motion data substantially matches the reference motion data, outputting the trigger indicating the security issue.

19. The computer program product of claim 17, wherein the program code further configures the electronic device to complete the functionality of:
in response to activation of the safe operating mode, de-activating at least one application of the electronic device to prevent access to secure information of the at least one application.

20. The computer program product of claim 17, wherein the program code further configures the electronic device to complete the functionality of:
in response to activation of the safe operating mode, preventing deletion of user data from the electronic device.
